(19) United States
(12) Patent Application Publication
(10) Pub. No.: US 2010/0049715 A1
(43) Pub. Date: Feb. 25, 2010

(54) CONTROLLED PARALLEL PROPAGATION OF VIEW TABLE UPDATES IN DISTRIBUTED DATABASE SYSTEMS

(75) Inventors: Hans-Arno Jacobsen, Toronto (CA); Ramana Yerneni, Cupertino, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/195,329

(22) Filed: Aug. 20, 2008

(51) Int. Cl. G06F 17/30

(52) U.S. Cl. 707/8; 707/200; 707/E17.005; 707/E17.007

(57) ABSTRACT

Aspects include mechanisms for design and analysis of flows of information in a database system from updates to base table records, through one or more log segments, to a plurality of view managers that respectively execute operations to update view table records. Mechanisms allow any base table record to be used by any view manager, so long as the view managers are using that base table record to update different view table records. Mechanisms also allow any number of view table records to be updated by any number of view managers, based on respective base table records. Mechanisms prevent the same view record from being used as a basis for updating the same base table record by more than one view manager, thereby preventing a conflict where updated information from one base table record is used more than once for updating a single view table record.

### BACKGROUND

1. Field

The following generally relates to database systems, and more particularly to parallel propagation of view table record updates, which are based on updates to base table records.

2. Related Art

Modern database systems comprise base tables that have directly updated data, and view tables that are derived from data obtained, directly or indirectly, from base tables (derived data). For example, a web store may use a base table for tracking inventory and another base table for tracking customer orders, and another for tracking customer biographical information. A person maintaining the web store may, for example, desire to analyze the data to prove or disprove certain hypotheses, such as whether a certain promotion was or would be successful, given previous order behavior, and other information known about customers. Such analysis can involve creating different views derived from, and dependent on, the base data.

The base tables are updated as changes are required to be reflected in the data. In other words, the base tables generally track or attempt to track facts, such as order placement, inventory, addresses, click history, and any number of other conceivable facts that may be desirable to store for future analysis or use.

Thus, when base tables are updated, view tables that depend on data in those updated base tables ultimately should be updated to reflect those updates. However, one concern is avoiding interference with transactions involving applications making changes to the base tables, because the responsiveness of such systems can affect a user's experience with the applications themselves (e.g., responsiveness of a web store or a search engine). Since derived data (e.g., the view tables) are used mostly for analytics and business planning, updates from base tables to view tables can occur “off-line”, to avoid burdening the systems that are supposed to be most responsive to users. For example, adjustments to a base table tracking inventory for a product need to be made when a unit of the product is sold. There may be a number of views that depend on a current inventory for that product.

In such traditional models of using base table data to derive various other ways to “view” or consider the meaning of the base table data, it is not imperative to provide elaborate mechanisms to avoid burdening real-time transaction systems or to ensure consistency in the view data during updating of such tables. Instead, it can often be enough that a simple stream or sequential log of each base table change can be provided to a view manager for processing. Such updates arrive in the log in an application-sequential order (could be time-sequential) and are processed in that order to update the view tables, thereby avoiding an issue of whether one base table update may be propagated to views before a factually earlier update. “Maintaining Views Incrementally” by Gupta, et al. SIGMOD 1993 (Washington D.C.) discloses background as to how a view can be incrementally maintained from base table updates spread through time.

However, views were updated more promptly, approximately a real-time update of each view every time a unit of that product were sold (and a unit for each of hundreds or thousands of other products), then such updating may pose a substantial burden on one or more of the system components.

Yet, simple parallelization of view updating does not ensure consistency of “view” (derived) data during base table updates. For example, a person sells 100 shares of CSCO and uses the proceeds to buy YHOO. Each of these transactions would be reflected as an update in one or more base tables, and factually (i.e., in the real-world), the sale occurred before the buy. However, if the base table update for the buy is reflected in a view (e.g., an account summary for the person) before the base table update for the sale, then that view will show an account state for the user that is factually inaccurate.

Some work has been done related to concerns about how to ensure that a view requiring multiple sources of base data is maintained with such base table data in a proper order. For example, “View Maintenance in a Warehousing Environment” by Zhuge, et al. SIGMOD 1995 (San Jose, Calif.) concerns situations where sources of base table updates can trigger a view update, but the view update is also dependent on other base data. Zhuge proposes a mechanism directed to using a proper version of the other base data, with respect to the base table update triggering the view update. Thus, Zhuge concerns avoiding using stale or out of sequence base data when two or more sources of base data are needed to maintain a view. However, Zhuge does not address concerns about increasing parallelization of base table record updates propagation to view updates.

### SUMMARY

Aspects include a system with a view manager configuration comprising a plurality of view managers that each track/propagate base table record updates by performing corresponding updates to the view table records. The view managers collectively may update in parallel the same view table record based on different updates to different base table records, and may update in parallel different view table records based on different updates to the same base table record. However, multiple view managers may not update in parallel the same view table record based on different updates to the same base table record. The view managers may execute on one or more computing resources.

The system includes a view manager configuration comprising a plurality of view managers that each may map multiple different base table record update. The view managers collectively may update in parallel the same view table record with different base data record updates, and may update in parallel multiple view table records with the same base table record update. However, multiple view managers may not use a single base table record update in updating in parallel the same view table record. The view managers may execute on one or more computing resources.

Such systems may further comprise a configuration manager operable to assign maintenance of views to view manager computing resources based on increasing parallelism of view maintenance and avoiding configurations where multiple of the view managers map one base table record update for updating the same view table record.

Other aspects include a database system analysis method comprising the receipt of data specifying a configuration of a system having one or more base tables. Each base table may be partitioned across one or more computing resources. Each partition is operable for producing indicators of base table record updates for reception by one or more log segments. A plurality of view managers is configured for receiving updates from the log segments and maintaining view records. The method also comprises identifying, based on the configuration, flows of base table record updates through the plurality of view managers, to update the view records.

Multiple of the view records may be updated based on any one base table record update. Multiple view records may be updated based on any one or more base table record updates, and one view record may be updated based on multiple base table record updates. The method also comprises flagging as improper any two or more flows that each cause the same base table record update to reach two or more different view managers, which also use that base table record update in maintaining the same view record.

Other aspects include methods and computer readable media embodying program code for effecting methods according to the examples described. Still other aspects include methods and systems allowing planning for new and/or revised view update programs, allocation, and reallocation of view management resources for supporting parallelization of view updating according to the following description.

### BRIEF DESCRIPTION OF THE DRAWINGS

FIG. 1 illustrates logical flows between base tables and view tables;

FIG. 2 illustrates a serial view record updating system;

FIG. 3 illustrates a logical organization of a parallelized view table record updating system, where flows of base table record updates can include multiple log segments, and multiple view managers updating multiple view table records and/or multiple view managers updating the same base table records;

FIG. 4 illustrates an example of a system according to the logical organization of FIG. 3, where storage and computing resources can be allocated for parallelized view table record updating with parallel view managers and parallel view table storage;

FIG. 5 illustrates steps of a first example method for detecting potential conflicts caused by parallelizing view updating; and

FIGS. 6 and 7 illustrate other examples where parallelization conflicts can be avoided during planning for new view tables based on proposed physical/logical configurations, as well as producing recommendations for parallelizing view table updating without causing conflicts.

### DETAILED DESCRIPTION

It was described in the background that a way to implement view table updates from base table updates is to provide a sequenced single log for a number of base tables to a number of views. In such an implementation, the single log receives base table updates sequentially at a tail end, and a view manager pulls log entries from a head end of the log, which can be seen to be a serial process that would be difficult to scale.

Providing parallelism to this serial updating process would be desirable, but the concerns of (1) keeping base table updating responsive and (2) keeping factually correct ordering of view updates dictate that parallelism be approached with caution.

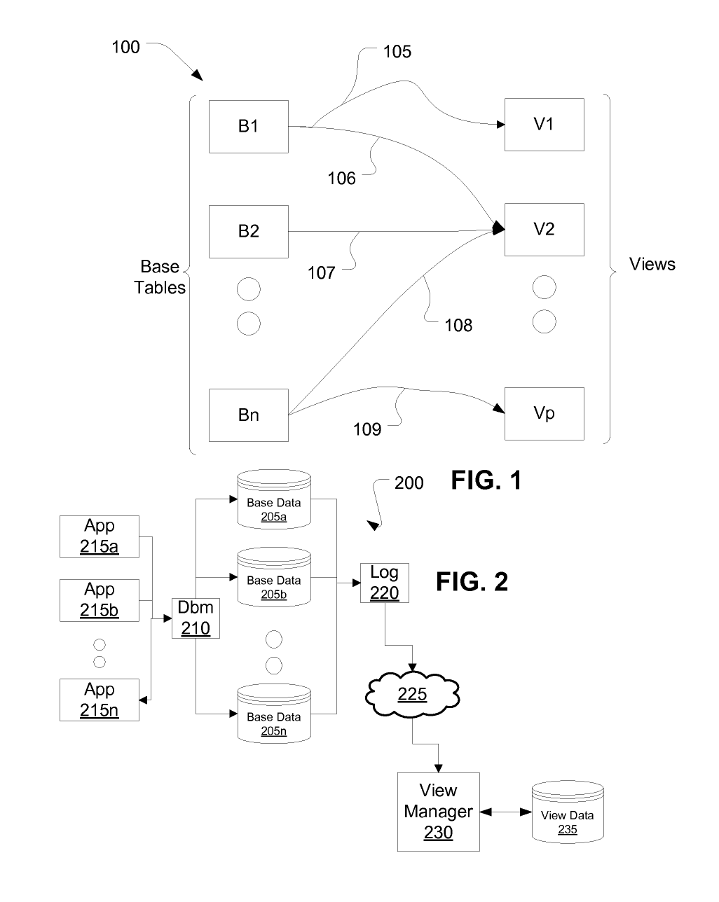

FIG. 1 illustrates a logical mapping 100 between base tables and view tables. In particular, base tables B₁, B₂ through Bₙ (i.e., a general situation where there are any number of base tables) all map to at least one view (view table), identified as V₁, V₂, through Vₚ (generalized example of any number of view tables). For example, base table B₁ maps through flow 105 to view V₁, and through flow 106 to view V₂. Likewise, B₂ maps through flow 107 to view V₂. Bₙ maps to view V₂ through flow 108 and to Vₚ through flow 109. Thus, FIG. 1 shows that any one or more base tables can be used as a basis for deriving data presented in any given view table. Table 1 illustrates a greatly abbreviated example of data that may be contained in a logical base table, entitled NASDAQ transactions. In this necessarily abbreviated example, Table 1 contains only a few records of transactions that took place in NASDAQ listed shares.

TABLE 1
NASDAQ Transactions

| Transaction | | | Number of | | | | Account |
|---|---|---|---|---|---|---|---|
| ID | Ticker | Action | Shares | Date | Time | Price | No. |
| Record 1 | INTC | Buy | 100 | Jun. 24, 2008 | 10:01:10 | 22.81 | A3432 |
| Record 2 | YHOO | Buy | 500 | Jun. 24, 2008 | 10:01:15 | 24.56 | A3437 |
| Record 3 | INTC | Sell | 200 | Jun. 24, 2008 | 10:02:10 | 22.85 | A3438 |
| . . . | | | | | | | |
| Record n | YHOO | Sell | 100 | Jun. 24, 2008 | 10:01:22 | 24.65 | A3421 |

Information that may be associated with each record entry includes a transaction ID, a ticker symbol, what type of trade, a number of shares, a date, a time, a price, and an account number. Of course, other information also could be associated with a record of this type, but the following provides an example for purposes of illustration. Thus, each time a trade occurs in a NASDAQ listed stock, the base table tracking such transactions would need to be updated to store a record for that trade. As can be quickly discerned, with over two billion shares of NASDAQ listed stocks being traded every day, keeping a base table current with a record of all such trades is resource intensive.

FIG. 2 illustrates aspects of an example architecture 200 wherein a base table can be partitioned across a number of computing resources, such that records needing to be added to Table 1 can be processed in parallel. In the context of these aspects and examples according to them, parallel can include that at least some portion of two items said to be concurrently (e.g., overlapping) at least partially in time. Overlap can also include overhead from concurrency management mechanisms. Parallel also can be more qualitative, in that parallel also invokes a situation where concurrency control or design is required to avoid conflicts between two actions (e.g., avoiding overwriting new data and/or reading stale data). In a more particular example, architecture 200 includes a plurality of storage locations for base data 205a-205n that can be called partitions of a base table. In the example of Table 1, where Table 1 can be said to be a base table representing all NASDAQ transactions, partitions of Table 1 can include the examples of Table 2 and Table 3, which are transactions for the specific ticker symbols INTC and YHOO. More generally, partitions of a base table can be along logical divisions. For example, if a base table were defined to include all items sold by a retail business, then partitions could be along the lines of departments or categories of items sold in the business.

TABLE 2
Partition YHOO Transactions -

| Transaction | | | Number of | | | | Account |
|---|---|---|---|---|---|---|---|
| ID | Ticker | Action | Shares | Date | Time | Price | No. |
| Record 2 | YHOO | Buy | 500 | Jun. 24, 2008 | 10:01:15 | 24.56 | A3437 |
| . . . | | | | | | | |
| Record n | YHOO | Sell | 100 | Jun. 24, 2008 | 10:01:22 | 24.65 | A3421 |

TABLE 3
Partition INTC Transactions

| Transaction | | | Number of | | | | Account |
|---|---|---|---|---|---|---|---|
| ID | Ticker | Action | Shares | Date | Time | Price | No. |
| Record 1 | INTC | Buy | 100 | Jun. 24, 2008 | 10:01:10 | 22.81 | A3432 |
| Record 3 | INTC | Sell | 200 | Jun. 24, 2008 | 10:02:10 | 22.85 | A3438 |

A database manager 210 communicates with the base data storage 205a-205n, and also with applications 215a-215n. Database manager 210 operates by receiving base table record updates from applications 215a-215n, such as stock trades in the example of Table 1, item sales in a retail establishment, and so on.

As such, applications 215a-215n can be any source of updates to the base data 205a-205n, and in the stock example, may include web interfaces receiving orders from online brokerage users, streams from private exchanges, and any other source of stock trades. In search, the applications can be various search engines that submit query and user interaction data for storage in base data 205a-205n. As can be understood by these examples, the applications represent any source of updates for base data 205a-205n.

In response to committing base table record updates to their respective memories each base data 205a-205n generates output to a log 220. FIG. 2 shows an example of a serial log/updating process, for contrast with later examples. Log 220 can be a First In/First Out (FIFO) queue to maintain the proper ordering of the base table record updates sent to it. The information in log 220 can be transmitted across a network 225 to a remote location. Often, the location is remote to provide redundancy and disaster protection by having 2 different physical locations where such data can be stored. At the remote location, there is a view manager 230 that is tasked with reading or pulling the updates from log 220. Again, to maintain the proper update ordering, the view manager 230 reads the base table update records from log 220 sequentially, and then runs view table update programs to determine what effects each base table record update has on views stored in view data 235. For example, when receiving an indication of the Record 1 update in Table 1 (i.e., bought 100 INTC), a view tracking the total shares traded in INTC would be updated by view manager 230.

As previously discussed, improper results can occur if base table record updates are applied out of an order presented in the queue. For example, a last trade price tracker necessarily needs to track the price of the last trade, and the order cannot be altered. Thus, outputs from base data 205a-205n to log 220, and from log 220 to view manager 230 are sequentially ordered.

As such, although there is a parallelization of base data, there is a serialization of updates coming from the storage of base data, through a FIFO log to a single view manager, in order to maintain correctness of view data updates. Although natural speed ups and progress of technology allow for increases in the speed of serial updating of such view data, such updating speed increases are largely incremental, and so this view updating strategy does not scale well. Such a situation may be acceptable, so long as the view data is used for post hoc analysis purposes, but many uses for more current view data would be enabled if the data were more current. Herein, parallelization of data flows used in updating the view data is provided, which can provide better scaling of such updating.

As explained herein, parallelization of updating of view tables is provided by parallelizing update paths through log segments, parallel view managers which can assume or be assigned portions of the updating workload, and parallel accessibility to the view records themselves. However, simple provision of parallel resources for these tasks would not yield correct results.

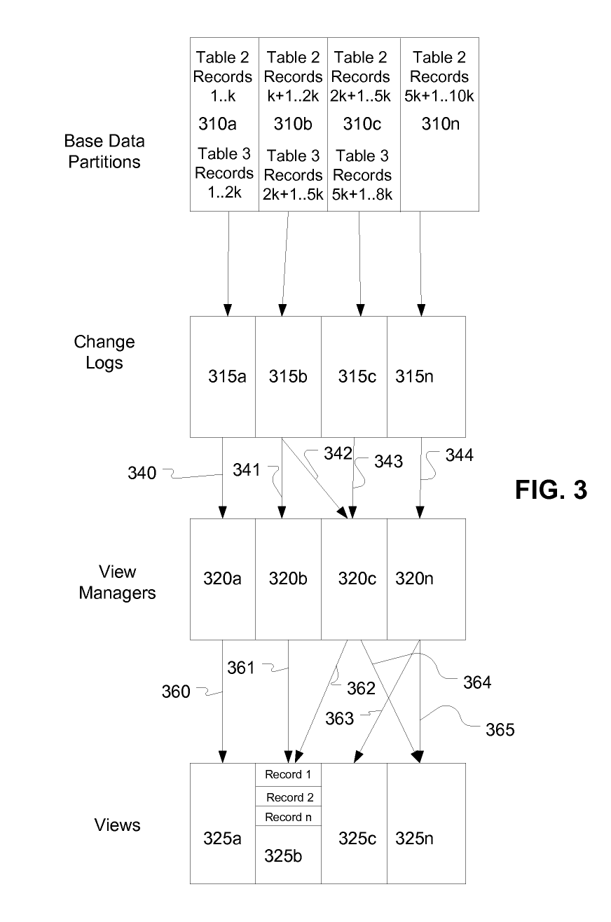

FIG. 3 illustrates parallelization of base table record updates through multiple log segments and multiple view managers for updating multiple views in parallel. In FIG. 3, base data storage resources 310a-310n store base data records and can be viewed, for simplicity, as being separate storage devices for such base data, but can be implemented in a variety of ways, such as by virtualization of larger storage resources, and so on. Each storage resource 310a-310n can store records for one or more base tables, such that base tables can be partitioned among the resources 310a-310n.

FIG. 3 illustrates that certain records of Table 2 above (i.e., INTC transactions) are stored in each of resource 310a-310n, and certain records of Table 3 (i.e., YHOO transactions) are stored in resources 310a-310c. Each resource 310a-310n is configured for outputting indications of updates made to base data records stored in it to a respective log segment of log segments 315a-315n. Such indications would include information sufficient at least for determining what base data is affected and what information changed in the base data.

Generally, it is preferred to map base data table partitions to log segments in a way that avoids a potential for sending updates relating to the same base table record to two or more log segments of log segments 315a-315n. Interfacing the base data table partitions to the log segments in this way allows an assumption that no single base table record update appears in multiple log segments when analyzing flows of record updates from base table partitions to view table partitions.

View managers 320a-320n are each operable to run one or more programs that define processes or implement propagation of view data. In other words, view managers 320a-320n each can obtain base data updates and produce/update various derivations of such data, and store or otherwise transmit or provide such derivations, which are identified as views 325a-325n. Each view would generally include multiple records, as illustrated with records 1-n of view 325b. To obtain the inputs for such derivations, each view manager subscribes to log segments from log segments 315a-315n to receive update indications from appropriate base tables. For example, if a view manager is maintaining a view for total trade volumes in INTC, then that view manager would subscribe to each log segment that had indications of updates for any record relating to an INTC trade. Or, if several view managers were maintaining such a view, then each may subscribe to a portion of the log segments, as described in more detail below.

Ultimately, the view managers update records in the views 325a-325n. In some cases, a view manager, when updating a view data record, can read a current value of the record, and perform an operation on that value, and then write a new value back. For example, if maintaining a total trade volume for a stock, then a present total trade volume would be read, incremented by a given trade size, and then the incremented value would be written back to the view table record.

Example mappings between log segments 315a-315n and view managers 320a-320n are respectively numbered 340-344. For example, log segment 315a is mapped to view manager 320a, while log segment 315b is mapped both to view manager 320b and 320c.

Likewise, view managers 320a-320n are shown as respectively maintaining records within certain of views 325a-325n, as shown by mappings 360-365. For example, view manager 320a maintains view 325a, as shown by mapping 360, while view manager 320b and view manager 320c are shown as maintaining record 1 of view 325b with mapping 361 and mapping 362 respectively. Likewise, view 325n is shown by mappings 364 and 365 as being maintained by view managers 320c and 320n.

In the above description, mappings of view managers to view records has largely been abstracted for clarity and ease of understanding. For example, a given view may have subtotal records for each of various items that all contribute to a record of an overall total of such items. Thus, in practice, a mapping of view managers to individual view records is preferably maintained, so that flows between base table record updates and view record updates are mapped, allowing greater parallelism.

FIG. 3 also illustrates that parallelization of view updating can be accomplished in two principal ways. One way is to distribute the maintenance of different view tables among multiple view managers. This way is helpful for distributing relatively small view tables that depend on relatively few base tables for maintenance among separate managers. A second way is to distribute updating of a single view table among multiple view managers. Distribution in the present sense includes allocating or otherwise reserving processing, storage, and/or communication resources for performing updates to a given set of view tables based on a given set of base table updates. In other words, a database can have a logical design, but ultimately, it needs to be implemented, but if such implementation is to provide parallel updating capability, the implementation may need coordination and/or organization so that parts of the implementation do not to interfere with each other during certain operations.

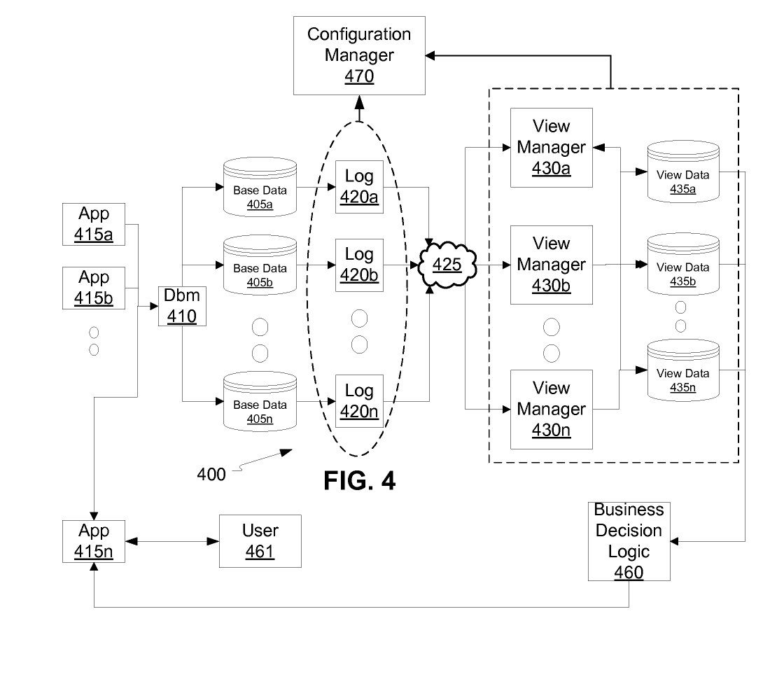

In the organization shown in FIG. 3, both kinds of parallelism can be implemented according to an example shown in FIG. 4, below. One aspect of these disclosures involves providing more parallelism to view update propagation, without causing any incorrect behavior.

To that end, any update to a base table record should be able to be provided to any number of view managers, and those view managers can propagate an update to any number of view records using that base table record update, so long as no two separate view managers attempt to update the same view table record with that single base table record update. For example, it is permissible to allow any base table update record to flow through any number of view managers to any number of distinct view table records. Likewise, many different base table record updates can flow through different view managers to update one view table record.

By particular example in FIG. 3, base data partition 310b (which contains table 2 records 1000-10000 and table 3 records 11000-15000) feeds updates to log segment 315b, which maps to view managers 320b and 320c. Therefore, it can be assumed that updates to the records stored in partition 310b are made available to view managers 320b and 320c.

However, it is not necessarily the case that each of view manager 320b and 320c uses each update present in log segment 315b to update a view table record, as each view manager may only need to obtain a portion of such updates for its own view maintenance purposes.

View manager 320b updates records only in view 325b (arrow 361), while view manager 320c also updates view records in view 325b and in view 325n (arrow 364). So long as the same view record is not updated by view manager 320b and by view manager 320c, based on a common base table record update (e.g., from log segment 315b), this configuration is permissible. So, it is determined whether any single record in view is updated by both view managers 320b and 320c, and if there is no such view record, then this flow is acceptable. However, if there is such a view record, then it must then be determined whether both view managers 320b and 320c use the same base table record update in updating that identified view record. Where more than one such view record is identified, this analysis must be undertaken for each such view record. Of course, the analysis of this data flow example could have proceeded oppositely, where commonality of base table update records used by view managers 320b and 320c was first detected. Then, for any base table update records used in common by these view managers, it would be determined whether there was any common view record updated with such base table record.

Another example configuration is that view manager 320c receives base table record updates from log segments 315b and 315c (arrows 342 and 343, respectively), and maintains view 325n, view manager 320n receives base table record updates from log segment 315n, and maintains view 325n. In this example configuration, so long as no single base table record update is available from any of log segments 315b, 315c, or 315n then there would not be a conflict between these view managers in updating any record in view 325n.

The above description described aspects of parallel data usage and updating (e.g., using in parallel base table record updates and updating in parallel view table records.) These aspects also can be described from a perspective of concurrent information usage and updating. For example, it was described that view managers can be performing a plurality of processing components to propagate base table record updates to view tables, including receiving base table record updates, performing computations on data, and then updating such view records based on the computations. Thus, each of a plurality of view managers may perform such processing components. In such a case, these processing components of plurality can be scheduled for concurrent execution on a processing resource, where the processing components are scheduled to be performed. For example, the components can be interleaved, can run in different threads, can be pipelined to use different system resources, and so on. Other examples of concurrent execution include using a plurality of physically distinct hardware resources, using virtual partitions of a computing resource, and so on. In any such cases, a plurality of view managers would be prevented from concurrently using the same base table record update for concurrently updating the same view table record update.

FIG. 4 illustrates an architecture 400 in which aspects related to flow analysis and control examples described above can be implemented. Architecture 400 includes that applications 415a-415n each can provide information to database manager 410 which controls how such information is captured in a plurality of storage resources 405a-405n for storing base table data. Each storage resource 405a-405n is a source for base table record updates for records maintained by it. For example, when a web site (e.g., identified as application 415a) registers a sale of a product, various information relating to the sale can be provided to database manager 410, including an order number, date and time information, SKU #, a price, biographical information for the purchaser, click information collected before and after the sale. These data may be maintained in one or more base tables. For example, there may be a base table tracking order number, date and time, SKU, and price information, and another base table for click information, and another for user biographical information.

So, database manager 410 controls where the constituent information parts are stored among resources 405a-405n, and then appropriate updates indicative of the new or updated information are sent from resources 405a-405n to respective log segments 420a-420n. The information in the log segments is provided across a communication network 425 to view managers 430a-430n; the communication network can comprise segments of a Local Area Network, Wide Area Networks, wireless broadbank links and so on. It is preferable that there is low latency between a log segment receiving a base table update and a view manager receiving that update from the log segment below, and so the communication network preferably is selected and/or designed with that goal. Also, the communication network 425 can have a plurality of physical and/or virtual paths such that each log segment can output data to multiple view managers 430a-430n.

As explained above, each view manager 430a-430n is responsible for maintaining one or more views stored in view data 435a-435n (can be shared responsibility with other of the view managers 430a-430n). As also explained above, each view manager 430a-430n would subscribe to receive updates from log segments containing updates to base table record(s) used in deriving its views (and new records that are needed in maintaining such views).

In FIG. 4, there also is business decision logic 460 that communicates with an application 415n, which in this example includes a web server and an e-commerce application interfacing with a user 461. Business decision logic 460 obtains data from view data 435a-435n. Business decision logic 460 uses such view data 435a-435n in creating and/or affecting one or more user experiences. For example, business decision logic can comprise advertising logic that determines based on view data an advertisement to display to a user. For example, view data can be maintained to expedite placement of orders for supplies, scheduling purposes, and a multitude of other purposes that if done on a shorter, more real-time basis, can be more effective.

From the perspective that updates to view table records are used as inputs in business decision logic, or as triggers for events, the view table records and the view tables themselves can be virtual, in that persistent storage of them is not required. For example, an update to a view table record can be generated, and used as a trigger for a certain event, such as selection and placement of an advertisement on a web page, and that update may not ultimately affect any content in persistent storage.

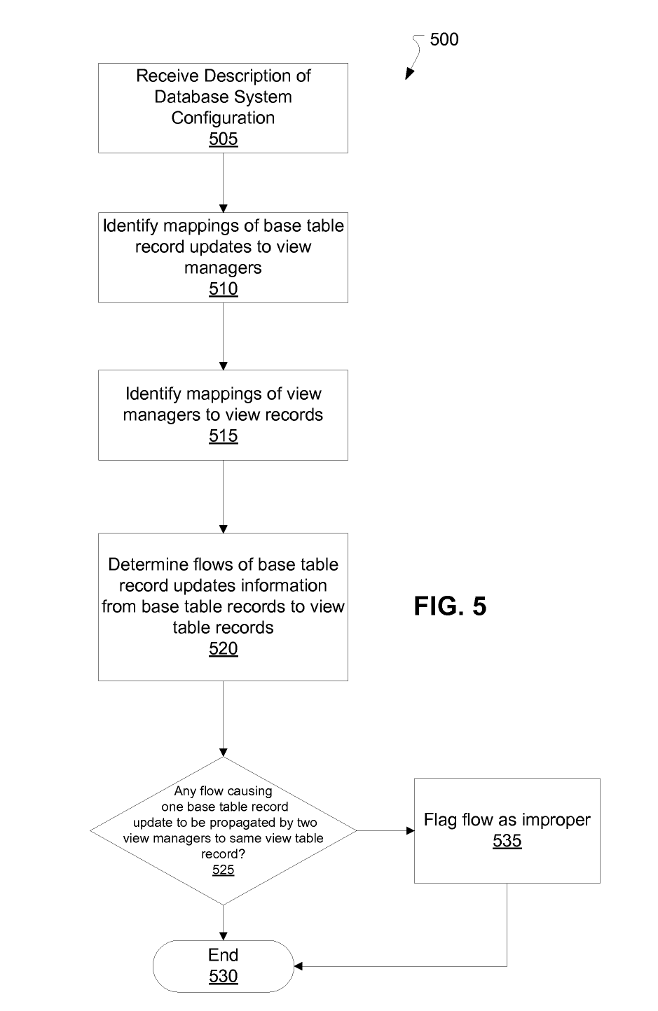

FIG. 5 illustrates steps of a method 500 relating to detection of potential conflicts between parallelized view managers, and in particular can represent steps taken by a configuration manager (e.g., configuration manager 470) for detecting such conflicts. Configuration manager 470 receives (505) a description of a database system configuration. This description can be generated by gathering information from a database implementation, such as that illustrated in FIG. 4, or based on inputs from a user desiring to examine a particular database configuration (can be a hypothetical configuration, for example). The database configuration can include a plurality of physically distinct resources that host base tables, multiple physically distinct computing resources that execute view update routines, and multiple physically distinct resources storing view table records updated by the view update routines. Here, physically distinct can include virtually subdividing a particular resource, so that it can be treated as multiple distinct resources.

Some of the base tables can be partitioned among multiple of the physically distinct resources. Similarly, one view update routine for updating a particular view can be executed by multiple view managers running on different of the computing resources for executing such update routines. Likewise, any view table also can be partitioned among multiple distinct resources for storage. Thus, large amounts of data and/or processing to update such data can be handled in parallel.

Information about how a given set of base tables, log segments, view managers, and view tables are configured supports the analysis steps identified in method 500. A first analysis step is that base table record updates are mapped to resources executing view update/management routines. In an example, base table record updates from a particular base table partition (if partitioned) can be mapped to one log segment (see FIG. 3 and FIG. 4), and in those situations, identification of subscription to a particular log segment can be substituted for direct identification of base table records. Also, method 500 includes identifying (515) mappings of view management routines to view table records which those routines update. For example, in a situation where a large number of base table records will be used in updating an aggregate view involving data from those records, multiple physically distinct resources may be executing the same view management routines to update that aggregate view (in the present example a view manager can include a combination of a computing resource configured for executing a given view management routine).

Then, based on the mappings identified in 510 and 515, flows of base table record updates from the physical resources where those updates originate (e.g., base data 405a-405n), through view managers (e.g., view managers 430a-430n) to view table records stored in potentially physically distinct resources (e.g., view data 435a-435n) are identified (520). So, in 520, dependencies between a particular update to a base table record and a particular view table record (including an intermediate path through a particular view manager) can be determined.

These flows are analyzed, and for any flow where more than one base table record update flows through multiple view managers to be used in updating the same view table record, there is a flag, or other indication, provided (535) that such a flow is potentially problematic and should be reviewed and/or revised. Method 500 then can end (530) after flagging any improper flows or otherwise failing to identify any improper flows.

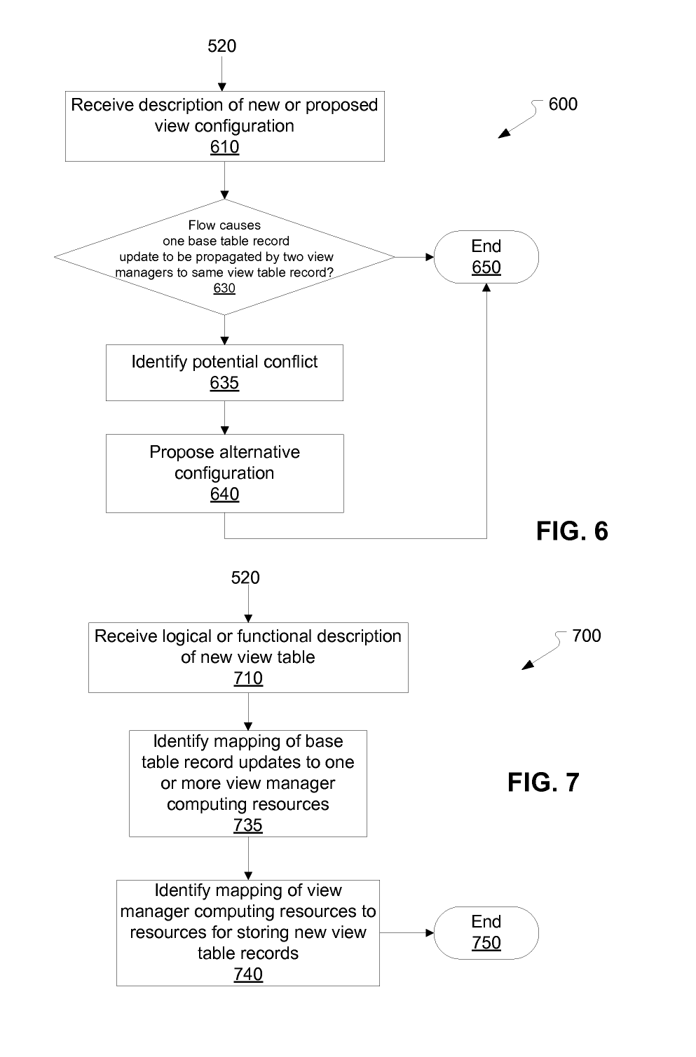

FIG. 6 illustrates steps of another example method 600, which can build on, or otherwise be integrated with, steps of method 500. Method 500 was primarily focused on reviewing existing flows of base table record updates to view table record updates. A related focus, however, is to allow planning of new view table maintenance support among the existing resources available. For example, if a business analyst desires to create a new view table, then it also is desirable to provide support for determining how to implement the maintenance of that new view table in database system, such as that of FIG. 4. Thus, method 600 shows that after step 520, a new or proposed view configuration can be received. This new proposed configuration/flow is analyzed (630) to determine if implemented whether it would result in a conflict. If so, then the potential conflict is identified 635. Such identification can include identifying which base table record or records is involved, as well as which view managers and view table records are involved. Method 600 also can propose an alternative configuration/flow that will avoid the conflict, while also producing the new view table desired, and with an appropriate degree of parallelism. For example, an alternative configuration can move execution of a different view update program from one computing resource to another, to free up resources that would not conflict. One potential conflict to be avoided is where portions of the base table record updates are available to different computing resources, such that not every computing resource can access any desired base table record update, and assignment of view record update propagation requiring particular base table record updates must be executed on a computing resource with access to such updates.

FIG. 7 illustrates another example method 700, where a logical or functional specification for a new view table can be determined to conflict or not with how existing view tables are maintained within an existing database system. For simplicity, method 700 also is shown as receiving output from step 520 (essentially, analyzing existing view table update configurations). Method 700 includes receiving a logical or functional description of a new view table that is to be supported in a database system. Such a logical or functional description may not include information relating to what computing resources may generate base table record updates, or other database system configuration information, such as what other view tables are maintained using what computing resources, etc. Rather, the logical or functional description would generally include information defining what information is needed, but not from where such information can be obtained.

Based on existing configuration information determined in the steps described with respect to FIG. 5, method 700 can include determining what log segments would contain base table record updates to be used in the newly specified view, and/or determining what computing resources may have partitions of base table records relevant for the new view. Also, in the presence of other mappings of base table records to view managers, it can be determined what view manager computing resources can or should be used for updating the new view (740). This determination also can include using information such as approximate computing power required for updating the new view. This information can be derived from base table size information, or can be included in the functional description. Then, the mappings of steps 735 and 740 can collectively be identified as part of a configuration maintaining the new view and other views. In some cases, such a configuration can include moving maintenance of pre-existing views to other computing resources, and other such operations. For example, it may be desirable to service updates to a given view record by three separate instantiations of a particular view update program (e.g., 3 update managers would be taking different base table record updates and using those updates in updating the same view table record), but loading on one of the computer resources used for view update program execution cannot take the additional load. Then, it may be necessary to shift a smaller view update program that overloaded view manager to free compute resources for the new view. After such steps, method 700 can end (750).

Methods, programs, and systems according to the above examples can help increase implementation of parallel view updating to create derived data. Examples may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. A “tangible” computer-readable medium expressly excludes software per se (not stored on a tangible medium) and a wireless, air interface. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

Those of skill in the art will appreciate that embodiments may be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

1. A system for parallelized maintenance of view table records based on base table records, comprising:
one or more storage devices for storing data representing one or more base tables divided into one or more partitions;
one or more log segments mapped to receive updates to records in the base table data; and
a view manager configuration operable for execution on one or more computing resources, the configuration comprising a plurality of view managers, each view manager capable of receiving base table record updates from one or more log segments and determining one or more updates to one or more views maintained by that view manager,
wherein the view managers of the configuration collectively may propagate updates in parallel to the same view table record, if the updates are based on different base table record updates, may propagate in parallel updates to multiple view table records that are based on the same base table record update, but may not propagate in parallel updates to the same view table record that are based on the same base table record update.

2. The system of claim 1, wherein the system comprises a plurality of computing resources for executing the view manager configuration, and further comprising a configuration manager operable to assign maintenance of views among the computing resources based on increasing parallelism of view maintenance and avoiding configurations where multiple of the view managers map one base table record update for updating the same view table record.

3. The system of claim 1, wherein the one or more storage devices for storing the data representing one or more base tables includes a plurality of storage devices, storing a plurality of base tables, and at least some of the plurality of base tables are partitioned among the plurality of storage devices.

4. The system of claim 1, wherein each view manager comprises a definition in which is indicated mapped base table records and which view table records that view manager updates, and further comprising logic for comparing these definitions to detect any two or more view managers that map a single base table record update and use that base table record update in updating the same view table record.

5. The system of claim 4, wherein the logic for comparing definitions also accepts a proposed new view manager definition and determines one or more view manager computing resources to assign to the new view manager that would not cause a conflict comprising mapping the same base table record updates through multiple of the view managers to update a single view table record.

6. The system of claim 5, wherein the logic is further operable for proposing a revised view manager definition in response to detecting the conflict.

7. The system of claim 1, wherein the one or more log segments comprises a plurality of log segments, the one or more view manager computing resources comprises a plurality of computing resources, and each of the plurality of computing resources receives updates from a subset of the plurality of log segments, further comprising view manager assignment logic operable to accept a definition for a proposed new view manager, and determine one or more view manager computing resources which receive updates to base table records on which the new view manager depends.

8. The system of claim 7, wherein the view manager assignment logic is further operable to identify a more parallelized view manager configuration for a more computationally intensive view manager.

9. The system of claim 7, wherein the view manager assignment logic is further operable to propose reassigning, to different view manager computing resources, an existing view manager to allow a preferred assignment of view manager computing resources for the proposed new view manager.

10. The system of claim 1, wherein one or more of the view tables are virtual, and updates to records contained therein function as event triggers for one or more applications.

11. The system of claim 10, wherein updates to the one or more virtual view tables, after use as respective event triggers are not stored persistently.

12. The system of claim 1, further comprising an application operable for using one or more view table record updates in a process affecting content displayed to a user via a web browser.

13. A database system analysis method, comprising:
receiving data specifying a configuration of a database system comprising a plurality of base tables, each base table comprising records stored in one or more computing resources, and each computing resource operable for outputting indicators of base table record updates for reception by one or more log segments, and a plurality of view managers configured for receiving updates from the log segments and maintaining view records;
identifying, based on the configuration, flows of base table record updates through the plurality of view managers, to update the view records; and
flagging as improper any two or more flows that each cause the same base table record update to reach two or more view managers, which also use that base table record update in maintaining the same view record.

14. The method of claim 13, wherein the one or more log segments comprise a plurality of log segments, the plurality of view managers collectively are executed on a plurality computing resources, and each of the plurality of computing resources maps to a subset of the log segments, further comprising:
receiving a new view update specification comprising an indication of one or more base tables from which record updates are to be used in updating a new view; and
assigning computations to be performed in updating the new view to one or more of the computing resources that map to log segments receiving updates from the indicated base tables, the assigning avoiding flows where any two view managers receive a base table update record and use that record to update the same view table record.

15. A database system, comprising:
one or more base tables, each comprising a plurality of records maintained in one or more partitions stored across one or more computing resources, each partition for each base table operable to receive record updates from applications, and output indications of such updates to one or more log segments;
a plurality of view managers, each configured for maintaining one or more view tables based on updates obtained from log segments receiving updates to base table records on which that view manager depends in updating a view which it is configured to maintain, wherein more than one of the view managers may be configured for maintaining any one of the views; and
a configuration manager operable for identifying as improper any configuration where more than one view manager of the plurality is configured to obtain updates to any single base table record, and also is configured to maintain a common view record using that single base table record update.

16. The system of claim 1, wherein each view manager comprises a definition in which is indicated mapped base table records and which view table records that view manager updates, and the configuration manager is operable by comparing these definitions to detect any two or more view managers that map a single base table record update and use that base table record update in updating the same view table record.

17. A computer readable medium computer executable instructions for a distributed database analysis method comprising:
receiving data specifying a configuration of a database system comprising a plurality of base tables, each base table comprising records stored in one or more computing resources, each computing resource operable for outputting indicators of base table record updates for reception by one or more log segments, and a plurality of view managers configured for receiving updates from the log segments and maintaining view records;
identifying, based on the configuration, flows of base table record updates through the plurality of view managers, to update the view records; and
flagging as improper any two or more flows that each cause the same base table record update to reach two or more view managers, which also use that base table record update in maintaining the same view record.

18. The system of claim 1, wherein the configuration comprises definitions for each view manager, which respectively indicate mapped base table records and which view table records that view manager updates, and the flagging includes comparing these definitions to detect any two or more view managers that map a single base table record update and use that base table record update in updating the same view table record.

19. A method of organizing a data base system, comprising:
providing storage for a base table partitioned across a plurality of storage devices;
providing a plurality of log segments to receive updates to records of the base table;
providing a plurality of view managers to obtain respective portions of the base table record updates from the log segments, and update a plurality of view table records based on the respectively obtained base table record updates;
allowing any single base table record update to be used by multiple of the view managers for updating different view table records;
allowing any single view table record to be updated based on multiple base table record updates; and
preventing any single base table record update from being used by more than one view manager to update the same view table record.
